(19) United States
(12) Patent Application Publication
(10) Pub. No.: US 2019/0376427 A1
(43) Pub. Date: Dec. 12, 2019

(54) CONTROL APPARATUS AND METHOD HAVING A CONTROL CLOSED LOOP OBSERVER CONFIGURATION FOR SCR/SCRF COMPONENT

(71) Applicant: GM GLOBAL TECHNOLOGY OPERATIONS LLC, Detroit, MI (US)

(72) Inventors: Giuseppe Mazzara Bologna, Nicosia (IT); Maria Camuglia, Francavilla di Sicilia (IT); Carlos Ildefonso Hoyos Velasco, Torino (IT); Carmen Pedicini, Torino (IT); David Tulli, Torino (IT); Daniele Bernardini, Siena (IT); Alberto Bemporad, Lucca (IT)

(73) Assignee: GM GLOBAL TECHNOLOGY OPERATIONS LLC, Detroit, MI (US)

(21) Appl. No.: 16/003,285

(22) Filed: Jun. 8, 2018

(51) Int. Cl. F01N 3/20; B01D 53/94; B01D 46/00; F01N 3/035

(52) U.S. Cl. CPC F01N 3/208; B01D 53/9418; B01D 53/9495; B01D 46/0027; F01N 2900/0404; F01N 2900/0414; B01D 2279/30; F01N 2510/06; F01N 3/035

(57) ABSTRACT

An exhaust gas after-treatment system for an internal combustion engine that includes a selective catalyst reduction on filter (SCRF) exhaust gas after-treatment device in communication with exhaust gases from the internal combustion engine and having a treated exhaust gas output. An oxides of nitrogen (NOx) sensor is coupled to the treated exhaust gases and has a NOx sensor output signal that is NOx and ammonia (NH₃) cross-sensitive. A closed loop observer (CLO) is operatively coupled to receive the NOx sensor output signal and provides a NOx concentration signal to an electronic control unit that is operatively associated with the exhaust gas after-treatment system and the internal combustion engine. The CLO output at least includes an exhaust gas NOx concentration estimate and the ECU is arranged to be operable upon the NOx concentration estimate to control the exhaust gas after-treatment system and the internal combustion engine to effect an overall reduction in actual NOx concentration with the exhaust gases.

### TECHNICAL FIELD

The technical field relates to a control apparatus for operating an internal combustion engine, and more particularly, the technical field relates to a control apparatus for operating an internal combustion engine to control a diesel selective catalyst reduction on filter (SCRF) exhaust gas after-treatment system.

### BACKGROUND

An internal combustion engine for a motor vehicle generally includes an engine block defining at least one cylinder accommodating a reciprocating piston coupled to rotate a crankshaft. The cylinder is closed by a cylinder head that cooperates with the reciprocating piston to define a combustion chamber. A fuel and air mixture is cyclically disposed in the combustion chamber and ignited, thereby generating hot expanding exhaust gasses that cause the reciprocating movements of the piston. The fuel is typically injected into each cylinder by a respective fuel injector. The fuel is provided at high pressure to each fuel injector from a fuel rail in fluid communication with a high pressure fuel pump that increases the pressure of the fuel received from a fuel source. Operation of the internal combustion engine is generally controlled by one or more electronic control units (ECUs) operably coupled to the internal combustion engine and an array of sensors and actuators, such as the fuel injector.

Due to stringent emissions regulation, internal combustion engines generally include exhaust gas after-treatment systems. An after-treatment system may include one or more after-treatment devices provided in an exhaust system of the internal combustion engine. For example, an after-treatment system may include an oxidation catalyst such as a diesel oxidation catalyst (DOC), which utilizes a chemical process in order to break down constituents from diesel engines in the exhaust stream, turning them into generally harmless compositions. DOCs typically have a honeycomb shaped configuration coated in a catalyst designed to trigger a chemical reaction to reduce these constituents. DOCs may contain palladium (Pd) and platinum (Pt) or cerium oxide, which serve as catalysts to oxidize hydrocarbons and carbon monoxide into carbon dioxide and water. An alternative to DOCs may be a three-way catalyst (TWC).

In a further alternative, a lean NOx trap (LNT) may be used. A LNT is a device that traps nitrogen oxides (NOx) contained in the exhaust gas and is generally located in the exhaust system upstream of a diesel particulate filter (DPF). More specifically, a LNT is a catalytic device containing catalysts, such as rhodium (Rh), Pt and Pd, and adsorbents, such as barium based elements, which provide active sites suitable for binding the nitrogen oxides (NOx) contained in the exhaust gas in order to trap them within the device itself.

After-treatment systems may also include a diesel particular filter (DPF) which filters the particulate matter (PM) and a selective catalytic reduction (SCR) device which is a catalytic device for reducing the nitrogen oxides (NOx) contained in the exhaust gas into diatomic nitrogen (N₂) and water (H₂O), with the aid of a gaseous reducing agent, typically ammonia (NH₃) that can be obtained by urea (CH₄N₂O) thermo-hydrolysis and that is absorbed inside the catalyst. Typically, urea is injected from a dedicated tank into the exhaust line where it mixes with the exhaust gas upstream the SCR. Other fluids can be used in a SCR in lieu of urea and are generally referred to as diesel exhaust fluids (DEF). An alternative to the SCR is a SCRF (SCR on Filter), namely a device that combines in a single unit an SCR device and a DPF.

Control of the after-treatment system, and in particular the control of the introduction of DEF to provide effective operation of the SCR/SCRF, requires development of a computationally intensive model of the SCR/SCRF. Furthermore, owing to the complexity of the SCR/SCRF models, existing after-treatment systems are provided only open loop control strategies augmented with complex adaptation strategies. Although performance of SCR/SCRF-based after-treatment systems might be significantly improved by them, SCR/SCRF-based after-treatment systems have not proven to be amenable to closed loop or other advanced control strategies.

### SUMMARY

In accordance with a herein described embodiment, an exhaust gas after-treatment system is provided for an internal combustion engine that includes a selective catalyst reduction on filter (SCRF) exhaust gas after-treatment device in communication with exhaust gases from the internal combustion engine and having a treated exhaust gas output. An oxides of nitrogen (NOx) sensor is in communication with the treated exhaust gases and has a NOx sensor output signal that is NOx and ammonia (NH₃) cross-sensitive. A closed loop observer (CLO) is operatively coupled to receive the NOx sensor output signal and provides a CLO output to an electronic control unit that is operatively associated with the exhaust gas after-treatment system and the internal combustion engine. The CLO output at least includes an exhaust gas NOx concentration estimate and the ECU is arranged to be operable upon the CLO output to control the exhaust gas after-treatment system and the internal combustion engine to effect an overall reduction in actual NOx concentration with the exhaust gases.

In accordance with a further herein described embodiment, an exhaust gas after-treatment system is provided for an internal combustion engine that includes a selective catalyst reduction on filter (SCRF) exhaust gas after-treatment device in communication with exhaust gases from the internal combustion engine and having a treated exhaust gas output. An oxides of nitrogen (NOx) sensor is in communication with the treated exhaust gases and has a NOx sensor output signal that is NOx and ammonia (NH₃) cross-sensitive. A closed loop observer (CLO) is operatively coupled to receive the NOx sensor output signal and provides a CLO output to an electronic control unit that is operatively associated with the exhaust gas after-treatment system and the internal combustion engine. The CLO output at least includes an exhaust gas NOx concentration estimate and the ECU is arranged to be operable upon the CLO output to control the exhaust gas after-treatment system and the internal combustion engine to effect an overall reduction in actual NOx concentration with the exhaust gases. The CLO output further includes an ammonia coverage ratio representing a quantity of ammonia stored within the SCRF device.

In accordance with a further herein described embodiment, an exhaust gas after-treatment system is provided for an internal combustion engine that includes a selective catalyst reduction on filter (SCRF) exhaust gas after-treatment device in communication with exhaust gases from the internal combustion engine and having a treated exhaust gas output. An oxides of nitrogen (NOx) sensor is in communication with the treated exhaust gases and has a NOx sensor output signal that is NOx and ammonia (NH₃) cross-sensitive. A closed loop observer (CLO) is operatively coupled to receive the NOx sensor output signal and provides a CLO output to an electronic control unit that is operatively associated with the exhaust gas after-treatment system and the internal combustion engine. The CLO output at least includes an exhaust gas NOx concentration estimate and the ECU is arranged to be operable upon the CLO output to control the exhaust gas after-treatment system and the internal combustion engine to effect an overall reduction in actual NOx concentration with the exhaust gases. The CLO output further includes estimated ammonia NH₃ concentration within the exhaust gases.

In accordance with a further herein described embodiment, an exhaust gas after-treatment system is provided for an internal combustion engine that includes a selective catalyst reduction on filter (SCRF) exhaust gas after-treatment device in communication with exhaust gases from the internal combustion engine and having a treated exhaust gas output. An oxides of nitrogen (NOx) sensor is in communication with the treated exhaust gases and has a NOx sensor output signal that is NOx and ammonia (NH₃) cross-sensitive. A closed loop observer (CLO) is operatively coupled to receive the NOx sensor output signal and provides a CLO output to an electronic control unit that is operatively associated with the exhaust gas after-treatment system and the internal combustion engine. The CLO output at least includes an exhaust gas NOx concentration estimate and the ECU is arranged to be operable upon the CLO output to control the exhaust gas after-treatment system and the internal combustion engine to effect an overall reduction in actual NOx concentration with the exhaust gases. The CLO further includes a selective catalyst reduction (SCR) model, and the SCR model is configured to provide an estimated ammonia NH₃ concentration within the exhaust gases.

In accordance with a further herein described embodiment, an exhaust gas after-treatment system is provided for an internal combustion engine that includes a selective catalyst reduction on filter (SCRF) exhaust gas after-treatment device in communication with exhaust gases from the internal combustion engine and having a treated exhaust gas output. An oxides of nitrogen (NOx) sensor is in communication with the treated exhaust gases and has a NOx sensor output signal that is NOx and ammonia (NH₃) cross-sensitive. A closed loop observer (CLO) is operatively coupled to receive the NOx sensor output signal and provides a CLO output to an electronic control unit that is operatively associated with the exhaust gas after-treatment system and the internal combustion engine. The CLO output at least includes an exhaust gas NOx concentration estimate and the ECU is arranged to be operable upon the CLO output to control the exhaust gas after-treatment system and the internal combustion engine to effect an overall reduction in actual NOx concentration with the exhaust gases. The CLO further includes a filter, the filter being configured to provide at least one parameter value to the SCR model.

In accordance with a further herein described embodiment, an exhaust gas after-treatment system is provided for an internal combustion engine that includes a selective catalyst reduction on filter (SCRF) exhaust gas after-treatment device in communication with exhaust gases from the internal combustion engine and having a treated exhaust gas output. An oxides of nitrogen (NOx) sensor is in communication with the treated exhaust gases and has a NOx sensor output signal that is NOx and ammonia (NH₃) cross-sensitive. A closed loop observer (CLO) is operatively coupled to receive the NOx sensor output signal and provides a CLO output to an electronic control unit that is operatively associated with the exhaust gas after-treatment system and the internal combustion engine. The CLO output at least includes an exhaust gas NOx concentration estimate and the ECU is arranged to be operable upon the CLO output to control the exhaust gas after-treatment system and the internal combustion engine to effect an overall reduction in actual NOx concentration with the exhaust gases. The CLO further includes a NOx sensor model, and the NOx sensor model is configured to provide the NOx concentration estimate.

In accordance with a further herein described embodiment, an exhaust gas after-treatment system is provided for an internal combustion engine that includes a selective catalyst reduction on filter (SCRF) exhaust gas after-treatment device in communication with exhaust gases from the internal combustion engine and having a treated exhaust gas output. An oxides of nitrogen (NOx) sensor is in communication with the treated exhaust gases and has a NOx sensor output signal that is NOx and ammonia (NH₃) cross-sensitive. A closed loop observer (CLO) is operatively coupled to receive the NOx sensor output signal and provides a CLO output to an electronic control unit that is operatively associated with the exhaust gas after-treatment system and the internal combustion engine. The CLO output at least includes an exhaust gas NOx concentration estimate and the ECU is arranged to be operable upon the CLO output to control the exhaust gas after-treatment system and the internal combustion engine to effect an overall reduction in actual NOx concentration with the exhaust gases. The CLO further includes a NOx sensor model, and the NOx sensor model is configured to provide the NOx concentration estimate. The CLO further has a filter configured to provide at least one parameter value to the NOx sensor model.

In accordance with a further herein described embodiment, an exhaust gas after-treatment system is provided for an internal combustion engine that includes a selective catalyst reduction on filter (SCRF) exhaust gas after-treatment device in communication with exhaust gases from the internal combustion engine and having a treated exhaust gas output. An oxides of nitrogen (NOx) sensor is in communication with the treated exhaust gases and has a NOx sensor output signal that is NOx and ammonia (NH₃) cross-sensitive. A closed loop observer (CLO) is operatively coupled to receive the NOx sensor output signal and provides a CLO output to an electronic control unit that is operatively associated with the exhaust gas after-treatment system and the internal combustion engine. The CLO output at least includes an exhaust gas NOx concentration estimate and the ECU is arranged to be operable upon the CLO output to control the exhaust gas after-treatment system and the internal combustion engine to effect an overall reduction in actual NOx concentration with the exhaust gases. Each of the CLO and the ECU are operatively coupled to receive an operating parameter of the internal combustion engine. The CLO and the ECU are further arranged to be operable upon the operating parameter to control the exhaust gas after-treatment system and the internal combustion engine to effect an overall reduction in actual NOx concentration with the exhaust gases.

In accordance with a further herein described embodiment, a vehicle includes an exhaust gas after-treatment system is provided for an internal combustion engine that includes a selective catalyst reduction on filter (SCRF) exhaust gas after-treatment device in communication with exhaust gases from the internal combustion engine and having a treated exhaust gas output. An oxides of nitrogen (NOx) sensor is in communication with the treated exhaust gases and has a NOx sensor output signal that is NOx and ammonia (NH₃) cross-sensitive. A closed loop observer (CLO) is operatively coupled to receive the NOx sensor output signal and provides a CLO output to an electronic control unit that is operatively associated with the exhaust gas after-treatment system and the internal combustion engine. The CLO output at least includes an exhaust gas NOx concentration estimate and the ECU is arranged to be operable upon the CLO output to control the exhaust gas after-treatment system and the internal combustion engine to effect an overall reduction in actual NOx concentration with the exhaust gases.

In accordance with a further herein described embodiment, a controller is provided for a vehicle internal combustion engine exhaust gas after-treatment system. The exhaust gas treatment system includes a selective catalyst reduction on filter (SCRF) exhaust gas after-treatment device in communication with exhaust gases from the internal combustion engine and having a treated exhaust gas output, an oxides of nitrogen (NOx) sensor coupled to the treated exhaust gas output. The NOx sensor has a NOx sensor output signal that is NOx and ammonia (NH₃) cross-sensitive. An electronic control unit (ECU) is operatively coupled to the internal combustion engine and the exhaust gas after-treatment system. The controller includes a closed loop observer (CLO) operatively coupled to receive the NOx sensor output signal and to provide a CLO output signal to the ECU. The CLO output signal at least includes an exhaust gas NOx concentration estimate. The ECU is arranged to be operable upon the NOx concentration estimate to control the exhaust gas after-treatment system and the internal combustion engine to effect an overall reduction in actual NOx concentration with the exhaust gases.

In accordance with a further herein described embodiment, a controller is provided for a vehicle internal combustion engine exhaust gas after-treatment system. The exhaust gas treatment system includes a selective catalyst reduction on filter (SCRF) exhaust gas after-treatment device in communication with exhaust gases from the internal combustion engine and having a treated exhaust gas output, an oxides of nitrogen (NOx) sensor coupled to the treated exhaust gas output. The NOx sensor has a NOx sensor output signal that is NOx and ammonia (NH₃) cross-sensitive. An electronic control unit (ECU) is operatively coupled to the internal combustion engine and the exhaust gas after-treatment system. The controller includes a closed loop observer (CLO) operatively coupled to receive the NOx sensor output signal and to provide a CLO output signal to the ECU. The CLO output signal at least includes an exhaust gas NOx concentration estimate. The ECU is arranged to be operable upon the NOx concentration estimate to control the exhaust gas after-treatment system and the internal combustion engine to effect an overall reduction in actual NOx concentration with the exhaust gases. The CLO output further includes ammonia coverage ratio representing a quantity of ammonia stored within the SCRF device.

In accordance with a further herein described embodiment, a controller is provided for a vehicle internal combustion engine exhaust gas after-treatment system. The exhaust gas treatment system includes a selective catalyst reduction on filter (SCRF) exhaust gas after-treatment device in communication with exhaust gases from the internal combustion engine and having a treated exhaust gas output, an oxides of nitrogen (NOx) sensor coupled to the treated exhaust gas output. The NOx sensor has a NOx sensor output signal that is NOx and ammonia (NH₃) cross-sensitive. An electronic control unit (ECU) is operatively coupled to the internal combustion engine and the exhaust gas after-treatment system. The controller includes a closed loop observer (CLO) operatively coupled to receive the NOx sensor output signal and to provide a CLO output signal to the ECU. The CLO output signal at least includes an exhaust gas NOx concentration estimate. The ECU is arranged to be operable upon the NOx concentration estimate to control the exhaust gas after-treatment system and the internal combustion engine to effect an overall reduction in actual NOx concentration with the exhaust gases. The CLO output further includes an estimated ammonia NH₃ concentration within the exhaust gases.

In accordance with a further herein described embodiment, a controller is provided for a vehicle internal combustion engine exhaust gas after-treatment system. The exhaust gas treatment system includes a selective catalyst reduction on filter (SCRF) exhaust gas after-treatment device in communication with exhaust gases from the internal combustion engine and having a treated exhaust gas output, an oxides of nitrogen (NOx) sensor coupled to the treated exhaust gas output. The NOx sensor has a NOx sensor output signal that is NOx and ammonia (NH₃) cross-sensitive. An electronic control unit (ECU) is operatively coupled to the internal combustion engine and the exhaust gas after-treatment system. The controller includes a closed loop observer (CLO) operatively coupled to receive the NOx sensor output signal and to provide a CLO output signal to the ECU. The CLO output signal at least includes an exhaust gas NOx concentration estimate. The ECU is arranged to be operable upon the NOx concentration estimate to control the exhaust gas after-treatment system and the internal combustion engine to effect an overall reduction in actual NOx concentration with the exhaust gases. The CLO includes a selective catalyst reduction (SCR) model, the SCR model being configured to provide an estimated ammonia NH₃ concentration within the exhaust gases.

In accordance with a further herein described embodiment, a controller is provided for a vehicle internal combustion engine exhaust gas after-treatment system. The exhaust gas treatment system includes a selective catalyst reduction on filter (SCRF) exhaust gas after-treatment device in communication with exhaust gases from the internal combustion engine and having a treated exhaust gas output, an oxides of nitrogen (NOx) sensor coupled to the treated exhaust gas output. The NOx sensor has a NOx sensor output signal that is NOx and ammonia (NH₃) cross-sensitive. An electronic control unit (ECU) is operatively coupled to the internal combustion engine and the exhaust gas after-treatment system. The controller includes a closed loop observer (CLO) operatively coupled to receive the NOx sensor output signal and to provide a CLO output signal to the ECU. The CLO output signal at least includes an exhaust gas NOx concentration estimate. The ECU is arranged to be operable upon the NOx concentration estimate to control the exhaust gas after-treatment system and the internal combustion engine to effect an overall reduction in actual NOx concentration with the exhaust gases. The CLO includes a filter, the filter that is configured to provide at least one parameter value to the SCR model.

In accordance with a further herein described embodiment, a controller is provided for a vehicle internal combustion engine exhaust gas after-treatment system. The exhaust gas treatment system includes a selective catalyst reduction on filter (SCRF) exhaust gas after-treatment device in communication with exhaust gases from the internal combustion engine and having a treated exhaust gas output, an oxides of nitrogen (NOx) sensor coupled to the treated exhaust gas output. The NOx sensor has a NOx sensor output signal that is NOx and ammonia (NH₃) cross-sensitive. An electronic control unit (ECU) is operatively coupled to the internal combustion engine and the exhaust gas after-treatment system. The controller includes a closed loop observer (CLO) operatively coupled to receive the NOx sensor output signal and to provide a CLO output signal to the ECU. The CLO output signal at least includes an exhaust gas NOx concentration estimate. The ECU is arranged to be operable upon the NOx concentration estimate to control the exhaust gas after-treatment system and the internal combustion engine to effect an overall reduction in actual NOx concentration with the exhaust gases. The CLO includes a NOx sensor model. The NOx sensor model is configured to provide the NOx concentration estimate.

In accordance with a further herein described embodiment, a controller is provided for a vehicle internal combustion engine exhaust gas after-treatment system. The exhaust gas treatment system includes a selective catalyst reduction on filter (SCRF) exhaust gas after-treatment device in communication with exhaust gases from the internal combustion engine and having a treated exhaust gas output, an oxides of nitrogen (NOx) sensor coupled to the treated exhaust gas output. The NOx sensor has a NOx sensor output signal that is NOx and ammonia (NH₃) cross-sensitive. An electronic control unit (ECU) is operatively coupled to the internal combustion engine and the exhaust gas after-treatment system. The controller includes a closed loop observer (CLO) operatively coupled to receive the NOx sensor output signal and to provide a CLO output signal to the ECU. The CLO output signal at least includes an exhaust gas NOx concentration estimate. The ECU is arranged to be operable upon the NOx concentration estimate to control the exhaust gas after-treatment system and the internal combustion engine to effect an overall reduction in actual NOx concentration with the exhaust gases. The CLO includes a filter configured to provide at least one parameter value to the NOx sensor model.

In accordance with a further herein described embodiment, a method is provided to control a vehicle internal combustion engine exhaust gas after-treatment system. The exhaust gas treatment system includes a selective catalyst reduction on filter (SCRF) exhaust gas after-treatment device that is in communication with exhaust gases from the internal combustion engine. A treated exhaust gas output from the SCRF device is coupled to an oxides of nitrogen (NOx) sensor. The NOx sensor has a NOx sensor output signal that is NOx and ammonia (NH₃) cross-sensitive. An electronic control unit (ECU) is operatively coupled to the internal combustion engine and to the exhaust gas after-treatment system. The method includes providing via a closed loop observer (CLO) operatively coupled to receive the NOx sensor output signal an exhaust gas NOx concentration estimate to the ECU. The exhaust gas after-treatment system and the internal combustion engine is controlled to effect an overall reduction in actual NOx concentration with the exhaust gases responsive to the NOx concentration estimate.

In accordance with a further herein described embodiment, a method is provided to control a vehicle internal combustion engine exhaust gas after-treatment system. The exhaust gas treatment system includes a selective catalyst reduction on filter (SCRF) exhaust gas after-treatment device that is in communication with exhaust gases from the internal combustion engine. A treated exhaust gas output from the SCRF device is coupled to an oxides of nitrogen (NOx) sensor. The NOx sensor has a NOx sensor output signal that is NOx and ammonia (NH₃) cross-sensitive. An electronic control unit (ECU) is operatively coupled to the internal combustion engine and to the exhaust gas after-treatment system. The method includes providing via a closed loop observer (CLO) operatively coupled to receive the NOx sensor output signal an exhaust gas NOx concentration estimate to the ECU. The exhaust gas after-treatment system and the internal combustion engine are controlled to effect an overall reduction in actual NOx concentration with the exhaust gases responsive to the NOx concentration estimate. The CLO further provides an estimated ammonia (NH₃) concentration within the exhaust gases, and the exhaust gas after-treatment system and the internal combustion engine are controlled to effect an overall reduction in actual NOx concentration with the exhaust gases responsive to the NOx concentration estimate and the estimated NH₃ concentration.

In accordance with a further herein described embodiment, a method is provided to control a vehicle internal combustion engine exhaust gas after-treatment system. The exhaust gas treatment system includes a selective catalyst reduction on filter (SCRF) exhaust gas after-treatment device that is in communication with exhaust gases from the internal combustion engine. A treated exhaust gas output from the SCRF device is coupled to an oxides of nitrogen (NOx) sensor. The NOx sensor has a NOx sensor output signal that is NOx and ammonia (NH₃) cross-sensitive. An electronic control unit (ECU) is operatively coupled to the internal combustion engine and to the exhaust gas after-treatment system. The method includes providing via a closed loop observer (CLO) operatively coupled to receive the NOx sensor output signal an exhaust gas NOx concentration estimate to the ECU. The exhaust gas after-treatment system and the internal combustion engine is controlled to effect an overall reduction in actual NOx concentration with the exhaust gases responsive to the NOx concentration estimate. The CLO further provides an ammonia coverage value and the exhaust gas after-treatment system and the internal combustion engine are controlled to effect an overall reduction in actual NOx concentration with the exhaust gases responsive to the NOx concentration estimate and the ammonia coverage value.

In accordance with a further herein described embodiment, a method is provided to control a vehicle internal combustion engine exhaust gas after-treatment system. The exhaust gas treatment system includes a selective catalyst reduction on filter (SCRF) exhaust gas after-treatment device that is in communication with exhaust gases from the internal combustion engine. A treated exhaust gas output from the SCRF device is coupled to an oxides of nitrogen (NOx) sensor. The NOx sensor has a NOx sensor output signal that is NOx and ammonia (NH₃) cross-sensitive. An electronic control unit (ECU) is operatively coupled to the internal combustion engine and to the exhaust gas after-treatment system. The method includes providing via a closed loop observer (CLO) operatively coupled to receive the NOx sensor output signal an exhaust gas NOx concentration estimate to the ECU. The exhaust gas after-treatment system and the internal combustion engine is controlled to effect an overall reduction in actual NOx concentration with the exhaust gases responsive to the NOx concentration estimate. Provided to the ECU and the CLO also is at least one internal combustion engine operating parameter. The exhaust gas after-treatment system and the internal combustion engine are controlled to effect an overall reduction in actual NOx concentration with the exhaust gases responsive to the NOx concentration estimate and the at least one internal combustion engine operating parameter.

### BRIEF DESCRIPTION OF THE DRAWINGS

The present disclosure will hereinafter be described in conjunction with the following drawing figures, wherein like numerals denote like elements.

FIG. 1 is a schematic representation of a vehicle incorporating an after-treatment system applied to an internal combustion engine that is operable in accordance with the herein described embodiments;

FIG. 2 is a block diagram illustration of an after-treatment system in accordance with the herein described embodiments; and

FIG. 3 is a block diagram illustration of a NOx sensor operable within an after-treatment system in accordance with the herein described embodiments.

### DETAILED DESCRIPTION OF THE DRAWINGS

The following detailed description is merely exemplary in nature and is not intended to limit the present disclosure or the application and uses of the present disclosure. Furthermore, there is no intention to be bound by any theory presented in the preceding background or the following detailed description. Exemplary embodiments will now be described with reference to the drawings, wherein conventional or commonly known elements may be omitted for clarity.

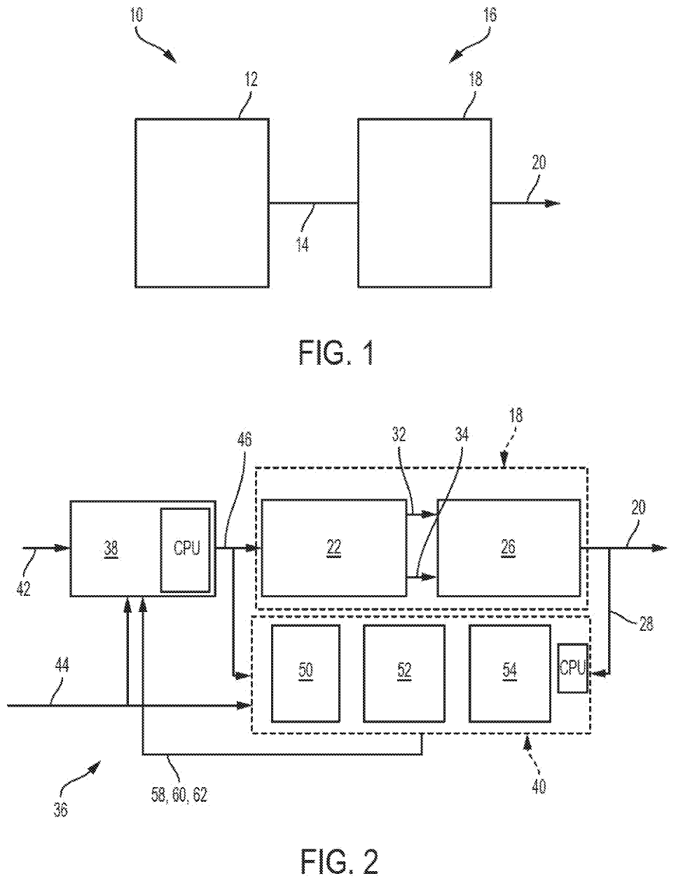

Some embodiments may include an automotive system 10, which as shown in FIG. 1 includes an internal combustion engine (ICE) 12 of conventional construction including an engine block defining at least one cylinder having a piston coupled to rotate a crankshaft. A cylinder head cooperates with the piston to define a combustion chamber. A fuel and air mixture is disposed in the combustion chamber and ignited, resulting in hot expanding exhaust gasses causing reciprocal movement of the piston. The fuel is provided by at least one fuel injector and the air through at least one intake port from an intake manifold. The fuel is provided at high pressure to the fuel injector from a fuel rail in fluid communication with a high-pressure fuel pump that increase the pressure of the fuel received a fuel source. Each of the cylinders has at least two valves, actuated by a camshaft rotating in time with the crankshaft. The valves selectively allow air into the combustion chamber and alternately allow exhaust gases to exit through an exhaust port.

The air may be distributed to the air intake port(s) through the intake manifold. An air intake duct may provide air from the ambient environment to the intake manifold. In other embodiments, a throttle body may be provided to regulate the flow of air into the manifold. In still other embodiments, a forced air system such as a turbocharger, having a compressor rotationally coupled to a turbine, may be provided. Rotation of the compressor increases the pressure and temperature of the air in the duct and manifold, and an intercooler disposed in the duct may reduce the temperature of the air.

Exhaust gases 14 produced by the ICE 12 are communicated to an exhaust system 16, which in accordance with the herein described embodiments includes an exhaust gas after-treatment system 18 including one or more exhaust after-treatment devices (not depicted in FIG. 1). The exhaust gases 14 are released from the after-treatment system 18 as treated exhaust gases 20. The after-treatment devices may be any device configured to change the composition of the exhaust gases 14. Some examples of after-treatment devices include, but are not limited to, catalytic converters (two and three way), such as a diesel oxidation catalyst (DOC), lean NOx traps, hydrocarbon adsorbers and selective catalytic reduction (SCR) systems. The after-treatment system 18 may further include a diesel particular filter (DPF), which may be combined with the SCR to provide an SCRF system. Other embodiments may include an exhaust gas recirculation (EGR) system coupled between the exhaust manifold and the intake manifold. The herein described embodiments are amenable to virtually any combination of after-treatment devices, and it is typical that the after-treatment system 18 will include more than one such device.

With continued reference to FIG. 1 and reference now also to FIG. 2, in addition to other after-treatment devices that may be provided within the after-treatment system 18 (not depicted in FIG. 2), the after-treatment system 18 includes a SCRF 22. To monitor composition of the treated exhaust gas 20, a NOx sensor 26 is furthermore provided. The NOx sensor 26 provides data in the form of an electric signal output (Cₛₑₙₛₒᵣ) 28 indicative of a concentration of NOx 32 and ammonia (NH₃) 34 in the treated exhaust gas from the SCRF 22 and emitted as exhaust gas 20.

A control structure 36 is operatively associated with the after-treatment system 16 and, in accordance with the herein described embodiments, includes an electronic control unit (ECU) 38 and a closed loop observer (CLO) 40. The ECU 38 and the CLO 40 are operatively coupled to receive data in the form of electronic signals from one or more sensors and/or devices associated with the ICE 12 represented as ICE sensor and modules data hereinafter referred to as UICE 42. The ECU 28 may receive UICE 42 signals from various sensors configured to generate the signals in proportion to various physical parameters associated with the ICE 12. The sensors include, but are not limited to, a mass airflow and temperature sensor, a manifold pressure and temperature sensor, a combustion pressure sensor, coolant and oil temperature and level sensors, a fuel rail pressure sensor, a cam position sensor, a crank position sensor, an exhaust pressure sensor and an exhaust temperature sensor, an EGR temperature sensor, and an accelerator pedal position sensor. Furthermore, the ECU 38 may generate output signals to various control devices that are arranged to control the operation of the ICE 12, including, but not limited to, the fuel injectors, the throttle body and other devices forming part of the after-treatment system 18. The ECU 38 may furthermore receive additional control inputs, such as but not limited to, ambient air temperature, ambient pressure, vehicle speed, gear selected, and the like, hereinafter CIs 44.

In accordance with herein described embodiments, the ECU 38 at least provides a DEF injection signal 46 causing the DEF system (not depicted) to inject a measured quantity of Diesel exhaust fluid or DEF into the exhaust gas flow upstream the SCRF 22. As is known, the DEF is hydrolysized to produce NH₃, which is reacted with the exhaust gas flow within the SCRF 22. An exhaust gas output of the SCRF 22 is exhaust gas consisting primarily of N₂ and H₂O, but also having NOx 32 and NH₃ 34 components.

The NOx sensor 26 is cross-sensitive to both NOx and NH₃, and the data signal Cₛₑₙₛₒᵣ 28 is a function of the NOx 32 and NH₃ 34 components, namely, the actual concentration of NOx or C_{NOx} and the actual concentration of NH₃ or C_{NH3} of the treated exhaust gas 20 output from the SCRF 22.

Each of the ECU 38 and the CLO 40 may include a digital central processing unit (CPU) having a microprocessor in communication with a memory system, or data carrier, and an interface bus. The microprocessor is configured to execute instructions stored as a program in the memory system, and send and receive signals to/from the interface bus. The memory system may include various storage types including optical storage, magnetic storage, solid-state storage, and other non volatile memory. The interface bus may be configured to send, receive, and modulate analog and/or digital signals to/from the various sensors and control devices. The program may embody the methods disclosed herein, allowing the ECU 38 and the CLO 40 to carryout out the steps of such methods and control the ICE 12 and after-treatment system 18. Instead of a CPU, the ECU 38 and/or the CLO 40 may have a different type of processor to provide the electronic logic, e.g. an embedded controller, an onboard computer, or any processing module that might be deployed in the automotive system 10.

The program stored in the memory system is transmitted from outside via a cable or in a wireless fashion. Outside the automotive system 10 it is normally visible as a computer program product, which is also called computer readable medium or machine readable medium in the art, and which should be understood to be a computer program code residing on a carrier, said carrier being transitory or non-transitory in nature with the consequence that the computer program product can be regarded to be transitory or non-transitory in nature.

An example of a transitory computer program product is a signal, e.g. an electromagnetic signal such as an optical signal, which is a transitory carrier for the computer program code. Carrying such computer program code can be achieved by modulating the signal by a conventional modulation technique such as QPSK for digital data, such that binary data representing said computer program code is impressed on the transitory electromagnetic signal. Such signals are e.g. made use of when transmitting computer program code in a wireless fashion via a WiFi connection to a laptop.

In case of a non-transitory computer program product the computer program code is embodied in a tangible storage medium. The storage medium is then the non-transitory carrier mentioned above, such that the computer program code is permanently or non-permanently stored in a retrievable way in or on this storage medium. The storage medium can be of conventional type known in computer technology such as a flash memory, an ASIC, a CD or the like.

In accordance with the herein described embodiments, the CLO 40 has three operative components, although the CLO 40 may have fewer than the depicted three components, the depicted components may be combined into fewer than three components or expanded to include more than three components. The CLO 40 may furthermore incorporate additional components and functionality associated with the operation of the ICE 12 and/or the after-treatment system 18. In the embodiment depicted in FIG. 2, the CLO 40 includes a selective catalyst reduction (SCR) model 50, a NOx sensor model 52 and a filter 54. The CLO 30 also is operatively coupled to receive the signal 28 from the NOx sensor 26, the DEF injection signal 46 and the UICE 42 data. The CLO 30 is operatively configured to provide an estimated ammonia coverage ratio (\hat{θ}) 58 estimated NH₃ concentration (ĈNH₃) 60 and estimated NOx concentration (Ĉ_{NOx}) 62 to the ECU 38. The ECU 38 is operatively configured as a closed loop controller employing any suitable control strategy to effect determination and injection of DEF via the DEF injection signal 46 to optimize the estimated concentration of NOx in the emitted exhaust gas 68 given UICE 42, CIs 44, \hat{θ} 58, CNH₃ 60 and Ĉ_{NOx} 62.

The SCR model 50 may be implemented in accordance with the herein described embodiments as a first order lumped model configured to determine the state:

x=Θθ

where x is the ammonia stored within the SCRF 18 in moles [mol], Θ is the maximum ammonia storage capacity and θ is ammonia coverage ratio. Given the following variables:
y₁ is the concentration of NOx at the outlet of the SCR in [g/s]
y₂ is the concentration of NH₃ at the outlet of the SCR in [g/s]
F is the exhaust mass flow in [m³/s]
Tₛₑₙₛₒᵣ is the temperature at the inlet of the SCR [K].
u₁ is the concentration of the NOx at the inlet of the SCR in [g/s].
u₂ is the concentration of NH₃ at the inlet of the SCR in [g/s].
MN_{H3} is the molar weight of NH₃ (17.031 [g/mol]).
M_{NOx} is the molar weight of NOx that has been approximated as NO only (30 [g/mol])
   and the coefficients:

a₁=e^{(k}^{₁}^{-k}^{₅}^{/T}^{ₛₑₙₛₒᵣ}⁾

a₂=e^{(k}^{₂}^{-k}^{₆}^{/T}^{ₛₑₙₛₒᵣ}⁾

a₃=k₃

a₄=e^{(k}^{₄}^{-k}^{₇}^{/T}^{ₛₑₙₛₒᵣ}⁾

a₅=k₈

x may be given as:

$$\{ \begin{matrix}x ( k + 1 ) = x ( k ) + {T}_{sampling} ( \frac{1}{{M}_{{NH}_{3}}} ( {u}_{2} - {y}_{2} ) - \frac{1}{{M}_{{NO}_{x}}} ( {u}_{1} - {y}_{1} ) ) - {a}_{1} x ) \\ {y}_{1} = \frac{{Fu}_{1}}{F + {a}_{2} x} \\ {y}_{2} = \frac{F ( {u}_{2} + {a}_{4} x )}{F + {a}_{5} - {a}_{3} x}\end{matrix}$$

where as described above:

y₁=C_{NO}_{ₓ} [g/s]

y₂=C_{NH}_{₃} [g/S]

u₁=C_{NO}_{_{x,in}} [g/S]

u₂=C_{NH}_{_{3,in}} [g/S]

F=[m³/s]

Tₛₑₙₛₒᵣ=[K]

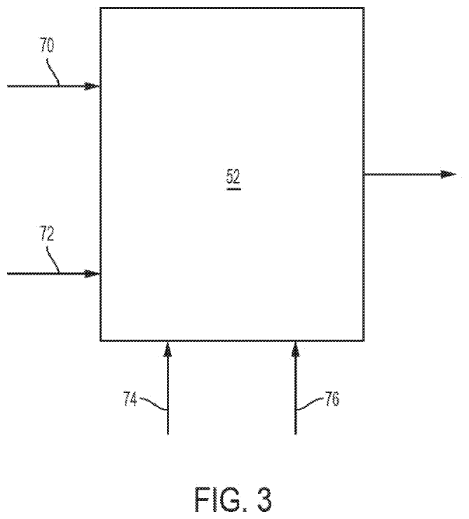

As noted above, the NOx sensor 26 is cross-sensitive to NH₃, which means it its not possible to have a pure NOx feedback when there is NH₃ present at the outlet of the SCRF 22, which is typical. With reference to FIG. 3, the NOx sensor model 52 takes into account the foregoing parameters: u₁ (70), u₂ (72), F (74), and Tₛₑₙₛₒᵣ (76) and provides the measured signal value yₘ (78), where:

yₘ=Ĉ_{NOx}+(ks1+ks2F+ks3Tₛₑₙₛₒᵣ+ks4F²)Ĉ_{NH}_{₃}

and from which Ĉ_{NO}_{ₓ} may be determined with the coefficents ks1-ks4 being determined by bench calibration.

The filter 54 may be implemented as an extended Kalman filter taking into consideration configuration of the CLO 40 and the NOx sensor 26 characteristics. The filter 54 takes as inputs (e.g., consumes) the NOx sensor 26 output 28 and in particular the NOx 32 and NH₃ 34 components of the SCRF 22 output gas, and is used to reconstruct the state (x) i.e., the ammonia coverage ratio stored within the SCRF 22.

The filter 54 utilizes a plurality of parameters in a typical arrangement. A first covariance matrix (Q) is the covariance matrix of the state (x). A second covariance matrix (R) is the covariance matrix of the NOx sensor 26 measurement. In the described exemplary embodiments, each of the matrices Q and R is 1×1 dimensional.

Based upon observation and mathematical principles applied to an open loop model implementation, the matrices Q and R can be implemented as:

$${Q}_{cov} = min \{ 1 , {z}_{1} \cdot ( Ym + 0.001 ) \}$$

$${R}_{cov} = \frac{{z}_{2}}{max ( Ym , 0.001 )}$$

where Yₘ is as given above and z₁ and z₂ are the tuning parameters of the Kalman filter. In this way, the CLO 40 takes feedback at least in the form of the NOx sensor 26 output and compensates for sensor cross-sensitivity while ensuring robust and continuous closed loop adjustment of after treatment system 18 performance in accordance with the herein described embodiments.

As will be appreciated from the foregoing discussion, to calibrate the CLO 40 it is necessary to identify the kⱼ terms of the SCR model 50, the ksⱼ terms of the NOx sensor model 52 and the zj terms of the filter 54. While any suitable methodology may be employed, in an exemplary implementation a one-third/two-thirds bench validation approach is used. For each of a plurality of measurement cycles (e.g., for each of an Artemis cycle, namely a world harmonized light vehicle test cycle (WLTC) and a Federal Test Procedure (FTP) cycle), a dataset is collected from bench testing. In accordance with experimental method and the herein described embodiments, two-thirds of the data is utilized for parameter determination while one-third of the dataset is used for validation for each of the datasets. In this manner, the required terms for the CLO 40 may be established.

While at least one exemplary embodiment has been presented in the foregoing detailed description, it should be appreciated that a vast number of variations exist. It should also be appreciated that the exemplary embodiment is only an example, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

What is claimed is:

1. An exhaust gas after-treatment system for an internal combustion engine comprising:
a selective catalyst reduction on filter (SCRF) exhaust gas after-treatment device in communication with a source of exhaust gases and having a treated exhaust gas output;
an oxides of nitrogen (NOx) sensor coupled to the treated exhaust gas output, the NOx sensor having a NOx sensor output signal that is NOx and ammonia (NH₃) cross-sensitive;
a closed loop observer (CLO) operatively coupled to receive the NOx sensor output signal and to provide a CLO output signal to an electronic control unit that is operatively associated with the exhaust gas after-treatment system and the internal combustion engine, wherein
the CLO output signal at least includes an exhaust gas NOx concentration estimate and the ECU is arranged to be operable upon the NOx concentration estimate to control the exhaust gas after-treatment system and the internal combustion engine to effect an overall reduction in actual NOx concentration with the exhaust gases.

2. The exhaust gas after-treatment system of claim 1, wherein the CLO output further comprises an ammonia coverage ratio representing a quantity of ammonia stored within the SCRF device.

3. The exhaust gas after-treatment system of claim 1, wherein the CLO output further comprises an estimated ammonia NH₃ concentration within the exhaust gases.

4. The exhaust gas after-treatment system of claim 1, wherein the CLO comprises a selective catalyst reduction (SCR) model, the SCR model being configured to provide an estimated ammonia NH₃ concentration within the exhaust gases.

5. The exhaust gas after-treatment system of claim 4, wherein the CLO comprises a filter, the filter being configured to provide at least one parameter value to the SCR model.

6. The exhaust gas after-treatment system of claim 1, wherein the CLO comprises a NOx sensor model, the NOx sensor model being configured to provide the NOx concentration estimate.

7. The exhaust gas after-treatment system of claim 6, wherein the CLO comprises a filter, the filter being configured to provide at least one parameter value to the NOx sensor model.

8. The exhaust gas after-treatment system of claim 1, wherein each of the CLO and the ECU are operatively coupled to receive an operating parameter of the internal combustion engine, wherein the CLO and the ECU are further arranged to be operable upon the operating parameter to control the exhaust gas after-treatment system and the internal combustion engine to effect an overall reduction in actual NOx concentration with the exhaust gases.

9. A vehicle comprising an exhaust gas after-treatment system in accordance with claim 1.

10. A controller for a vehicle internal combustion engine exhaust gas after-treatment system, the exhaust gas treatment system including a selective catalyst reduction on filter (SCRF) exhaust gas after-treatment device in communication with exhaust gases from the internal combustion engine and having a treated exhaust gas output, an oxides of nitrogen (NOx) sensor coupled to the treated exhaust gas output, the NOx sensor having a NOx sensor output signal that is NOx and ammonia (NH₃) cross-sensitive, and an electronic control unit (ECU) operatively coupled to the internal combustion engine and the exhaust gas after-treatment system, the controller comprising:
a closed loop observer (CLO) operatively coupled to receive the NOx sensor output signal and to provide a CLO output signal to the ECU, wherein the CLO output signal at least includes an exhaust gas NOx concentration estimate and the ECU is arranged to be operable upon the NOx concentration estimate to control the exhaust gas after-treatment system and the internal combustion engine to effect an overall reduction in actual NOx concentration with the exhaust gases.

11. The controller of claim 10, wherein the CLO output further comprises an ammonia coverage ratio representing a quantity of ammonia stored within the SCRF device.

12. The controller of claim 10, wherein the CLO output further comprises an estimated ammonia NH₃ concentration within the exhaust gases.

13. The controller of claim 10, wherein the CLO comprise a selective catalyst reduction (SCR) model, the SCR model being configured to provide an estimated ammonia NH₃ concentration within the exhaust gases.

14. The controller of claim 13, wherein the CLO comprises a filter, the filter being configured to provide at least one parameter value to the SCR model.

15. The controller of claim 10, wherein the CLO comprises a NOx sensor model, the NOx sensor model being configured to provide the NOx concentration estimate.

16. The controller of claim 15, wherein the CLO comprises a filter, the filter being configured to provide at least one parameter value to the NOx sensor model.

17. A method of controlling a vehicle internal combustion engine exhaust gas after-treatment system, the exhaust gas treatment system including a selective catalyst reduction on filter (SCRF) exhaust gas after-treatment device in communication with exhaust gases from the internal combustion engine and having a treated exhaust gas output, an oxides of nitrogen (NOx) sensor coupled to the treated exhaust gas output, the NOx sensor having a NOx sensor output signal that is NOx and ammonia (NH₃) cross-sensitive, and an electronic control unit (ECU) operatively coupled to the internal combustion engine and the exhaust gas after-treatment system, the method comprising:
providing via a closed loop observer (CLO) operatively coupled to receive the NOx sensor output signal an exhaust gas NOx concentration estimate to the ECU; and
controlling the exhaust gas after-treatment system and the internal combustion engine to effect an overall reduction in actual NOx concentration with the exhaust gases responsive to the NOx concentration estimate.

18. The method of claim 17, wherein providing via a CLO an exhaust gas NOx concentration estimate further comprises:
providing an estimated ammonia (NH₃) concentration within the exhaust gases, and
controlling the exhaust gas after-treatment system and the internal combustion engine to effect an overall reduction in actual NOx concentration with the exhaust gases responsive to the NOx concentration estimate and the estimated NH₃ concentration.

19. The method of claim 17, wherein providing via a CLO an exhaust gas NOx concentration estimate further comprises providing an ammonia coverage ratio, and controlling the exhaust gas after-treatment system and the internal combustion engine to effect an overall reduction in actual NOx concentration with the exhaust gases responsive to the NOx concentration estimate and the ammonia coverage ratio.

20. The method of claim 17, further comprising providing at least one internal combustion engine operating parameter to the ECU and controlling the exhaust gas after-treatment system and the internal combustion engine to effect an overall reduction in actual NOx concentration with the exhaust gases responsive to the NOx concentration estimate and the at least one internal combustion engine operating parameter.
